(19) United States
(12) Patent Application Publication
(10) Pub. No.: US 2010/0058251 A1
(43) Pub. Date: Mar. 4, 2010

(54) OMNIDIRECTIONAL GESTURE DETECTION

(75) Inventors: Ben ROTTLER, San Francisco, CA (US); Policarpo Wood, Cupertino, CA (US); Kourtny Hicks, Sunnyvale, CA (US); Matt Rogers, Los Gatos, CA (US)

Correspondence Address: APPLE c/o MOFO NOVA, 1650 TYSONS BLVD., SUITE 300, MCLEAN, VA, 22102, US

(73) Assignee: Apple Inc., Cupertino, CA (US)

(21) Appl. No.: 12/199,532

(22) Filed: Aug. 27, 2008

(51) Int. Cl. G06F 3/14

(52) U.S. Cl. 715/863

(57) ABSTRACT

An omnidirectional electronic device is disclosed. The electronic device can perform operations associated with a combination of inputs that can, in some cases, be recognized irrespective of the position or orientation in which they are applied to the electronic device. The inputs can include, for example, single or multi-touch taps, presses, swipes, rotations, characters and symbols. The inputs can be provided one or more times in succession and can be held for an amount of time. In one embodiment, an omnidirectional media player can perform media operations associated with a combination of inputs that can be recognized irrespective of the position or orientation in which they are applied to an input area of the media player.

### FIELD OF THE DISCLOSURE

This relates generally to input detection, and more particularly to detecting input applied to an omnidirectional device.

### BACKGROUND

Several kinds of input devices exist for performing operations in portable electronic devices. Some examples of input devices include buttons, switches, keyboards, mice, trackballs, touch pads, joy sticks, touch screens and the like. Some examples of portable electronic devices include media players, remote controls, personal digital assistants (PDAs), cellular phones, etc.

A user can cause an operation to be performed in a portable electronic device by applying an input to an input device. In one example, a user can move a cursor displayed on a display screen of the portable electronic device by touching an input device in a particular motion. In another example, a user can select an item displayed on the display screen by pressing an input device in a particular location.

However, portable electronic devices tend to be held and viewed by a user in a particular orientation relative to the user. Accordingly, the type of input recognizable by portable electronic devices can be constrained by the orientation in which the devices operate.

### SUMMARY

To improve the usability of a portable electronic device, a portable electronic device is disclosed that can perform operations associated with an input irrespective of the position or orientation in which the input is applied to an input area of the device.

Such a device can be considered omnidirectional, since it can be controlled and operated in the same manner despite its relative orientation to the user. In some embodiments, such a device can enable sightless navigation, whereby a user can easily control the device without looking at it.

In one embodiment, an omnidirectional electronic device can be provided. The omnidirectional electronic device can perform operations associated with a combination of inputs that can, in some cases, be recognized irrespective of the position or orientation in which they are applied to an input area of the electronic device. The inputs can include, for example, single or multi-touch taps, presses, swipes, rotations, characters and symbols. The inputs can be provided one or more times in succession and can be held for an amount of time.

This type of input recognition can be advantageous in situations in which a user desires to provide input without coordinating the input with device orientation or visual feedback from a display of the electronic device. One such situation can include the electronic device, such as a media player, being attached to clothing of a user during a workout, for example. Due to the omnidirectional nature of the media player, a user can operate the media player in the same manner without regard to whether the media player is attached to the user in an upward, downward, sideways or other orientation.

### BRIEF DESCRIPTION OF THE DRAWINGS

FIG. 1 illustrates an example of an electronic device.

FIG. 2 illustrates an example of an electronic device.

FIG. 3 illustrates an example of a 17-element capacitive sensor element arrangement.

FIGS. 4A-4C illustrate examples of 15-element capacitive sensor element arrangements.

FIG. 5 illustrates an example of a 30-element capacitive sensor element arrangement.

FIGS. 6A-6C illustrate examples of 9-element capacitive sensor element arrangements.

FIG. 7 illustrates an example of a process for performing an operation irrespective of input position.

FIGS. 8A-8I illustrate examples of a single point input.

FIG. 9 illustrates an example of a process for performing a operation irrespective of input orientation.

FIGS. 10A-10H illustrate examples of a linear input.

FIG. 11 illustrates an example of a multiple point input.

FIG. 12 illustrates an example of a multiple point input.

FIG. 13 illustrates an example of a gestural input.

FIG. 14 illustrates an example of a gestural input.

FIGS. 15A-15B illustrate examples of multi-touch linear inputs.

FIGS. 16A-16B illustrate examples of multi-touch rotational inputs.

FIGS. 17A-17B illustrate examples of multi-touch rotational inputs.

FIGS. 18A-18C illustrate an example of operations of an input device.

FIG. 19 illustrates an example of an input device.

FIG. 20 illustrates an example of a computing system.

FIGS. 21A-21D illustrate examples of applications of input devices.

FIGS. 22A-22B illustrate an example of an installation of an input device into a media player.

FIG. 23 illustrates an example of a remote control incorporating an input device.

### DETAILED DESCRIPTION

The present disclosure describes embodiments of a portable electronic device that can perform operations associated with an input irrespective of the position or orientation in which the input is applied to an input area of the device. Such a device can be considered omnidirectional, since it can be controlled and operated in the same or similar manner despite its relative orientation to the user, gravity or any other frame of reference. Such a device can also enable sightless navigation in some embodiments, whereby a user can control the device with ease without looking at the device.

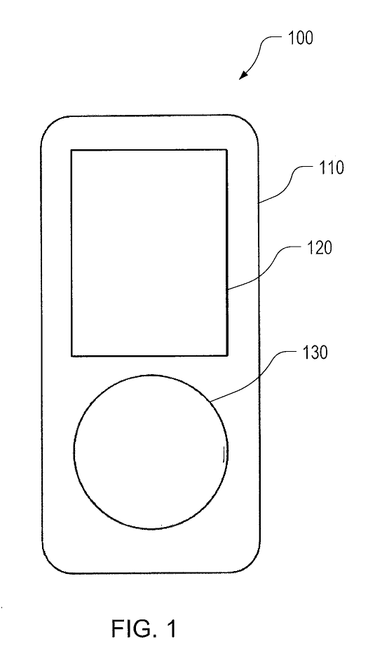

FIG. 1 illustrates an example of an electronic device. The electronic device may be any consumer electronic product. The electronic device may be a computing device and more particularly it may be a media player, PDA, phone, remote control, camera and the like. In the embodiment illustrated in FIG. 1, the electronic device 100 may correspond to a media player. The term “media player” generally refers to computing devices dedicated to processing media such as audio, video or other images, including, for example, music players, game players, video players, video recorders and the like. These devices can be portable to allow a user to, for example, listen to music, play games or video, record video or take pictures wherever the user travels. In one embodiment, the electronic device can be a handheld device that is sized for placement into a pocket of the user. By being pocket sized, the device may be taken almost anywhere the user travels (e.g., the user is not limited by carrying a large, bulky and often heavy device, as in a portable computer). Furthermore, the device can be operated in the user's hands, thus no reference surface such as a desktop is required.

Electronic devices (e.g., media players) generally have connection capabilities that allow a user to upload and download data to and from a host device, such as a general purpose computer (e.g., desktop computer, portable computer, etc.). For example, in the case of a camera, photo images can be downloaded to the general purpose computer for further processing (e.g., printing). With regard to music players, for example, songs and play lists stored on the general purpose computer can be downloaded into the music player. In the embodiment illustrated in FIG. 1, electronic device 100 can be a pocket-sized hand-held media player (e.g., MP3 player) that allows a user to store a collection of music, photos, album art, contacts, calendar entries, and other desirable media assets. It should be appreciated however, that media players are not a limitation as the electronic device may be embodied in other forms as mentioned above.

As shown in FIG. 1, electronic device 100 may include housing 110 that can enclose various electrical components, such as integrated circuit chips and other circuitry, for example. The integrated circuit chips and other circuitry may include, for example, a microprocessor, memory (e.g., ROM, RAM), a power supply (e.g., battery), a circuit board, a hard drive or Flash (e.g., Nand flash) for storing media for example, one or more orientation detection elements (e.g., accelerometer) and various input/output (I/O) support circuitry. In the case of music players, the electrical components can include components for outputting music such as an amplifier and a digital signal processor (DSP) for example. In the case of video recorders or cameras the electrical components can include components for capturing images such as image sensors (e.g., charge coupled device (CCD) or complimentary oxide semiconductor (CMOS)) or optics (e.g., lenses, splitters, filters) for example. In addition to the above, the housing can also define the shape or form of the electronic device. That is, the contour of housing 102 may embody the outward physical appearance of electronic device 100 in one embodiment.

Electronic device 100 may also include display screen 120. Display screen 120 can be used to display a graphical user interface as well as other information to the user (e.g., text, objects, graphics). By way of example, display screen 120 may be a liquid crystal display (LCD). In one embodiment, the display screen can correspond to a X-by-Y pixel high-resolution display, with a white LED backlight to give clear visibility in daylight as well as low-light conditions. Display screen 120 can also exhibit a “wide screen” aspect ratio (e.g., similar to a 16:9 aspect ratio) such that it may be relatively easy to perceive portrait and landscape orientations.

Electronic device 100 may also include input device 130. Input device 130 can be configured to provide one or more control functions for controlling various applications associated with electronic device 100. For example, a control function can be used to move an object or perform an action on display screen 120 or to make selections or issue commands associated with operating electronic device 100. Input device 130 may be widely varied. In one embodiment, input device 130 can include a rigid sensor mechanism for detecting input. The rigid sensor mechanism can include, for example, a touch sensitive surface that provides location information for an object, such as a finger for example, in contact with or in proximity to the touch sensitive surface. In another embodiment, input device 130 can include one or more movable sensor mechanisms for detecting input. The movable sensor mechanism can include, for example, one or more moving members that actuate a switch when a particular area of input device 130 is pressed. The movable sensor mechanism may operate as a mechanical push button and perform a clicking action when actuated. In a further embodiment, input device 130 may include a combination of a rigid sensor mechanism and one or more movable sensor mechanisms.

An example of an input device comprising a rigid sensor mechanism may be found in U.S. Pat. No. 7,046,230 entitled “Touch Pad Handheld Device,” which is incorporated herein by reference in its entirety. An example of an input device comprising a combination of a rigid sensor mechanism and a movable sensor mechanism may be found in U.S. patent application Ser. No. 11/812,383 entitled “Gimballed Scroll Wheel,” filed Jun. 18, 2007, which is incorporated herein by reference in its entirety.

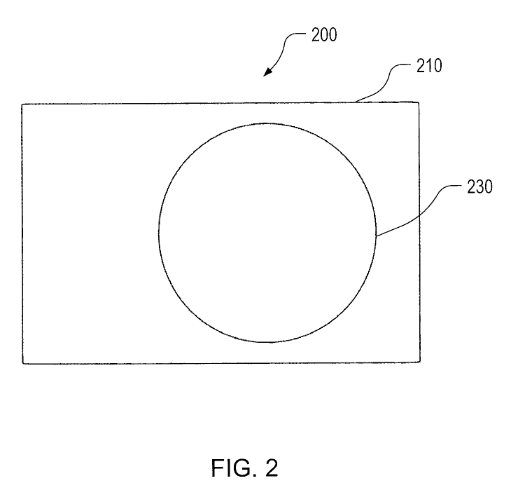

FIG. 2 illustrates an embodiment of an electronic device without a display screen. In the embodiment illustrated in FIG. 2, electronic device 200 may include housing 210 that may generally correspond to housing 110, and input device 230 that may generally correspond to input device 130. The lack of a display screen allows electronic device 200 to be configured with smaller dimensions than those of electronic device 100. For example, in one embodiment, electronic device 200 may be less than two inches wide and less than two inches tall.

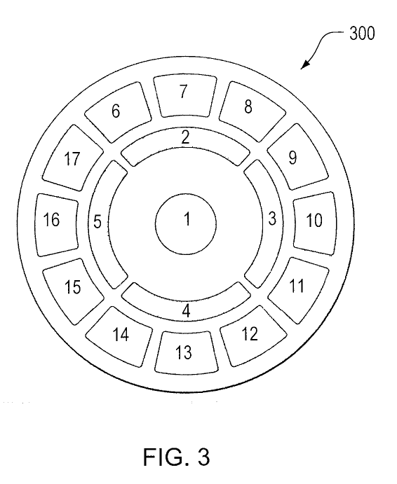

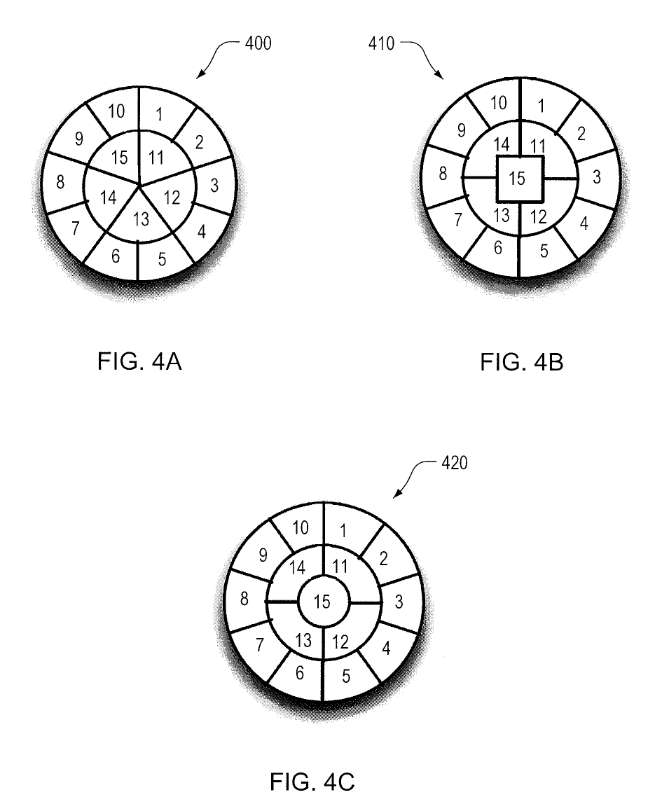

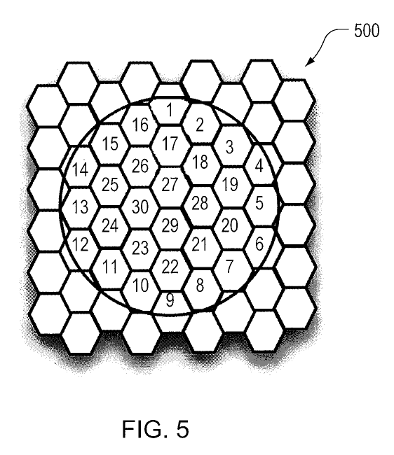

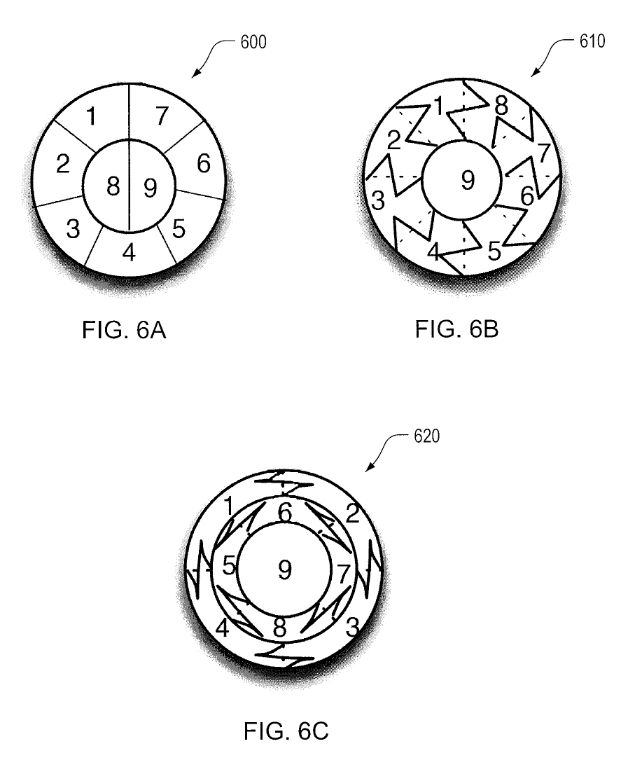

FIGS. 3-6 illustrate examples of some arrangements of capacitive sensor elements that can be configured to sense touch events caused by an object, such as a finger, in contact with or in proximity to a touch sensitive surface of an input device corresponding to the embodiments described above. FIG. 3 illustrates an example of 17-element arrangement. FIGS. 4A-4C illustrate examples of 15-element arrangements. FIG. 5 illustrates an example of a 30-element element arrangement. FIGS. 6A-6C illustrate examples of 9-element arrangements.

Touch events detectable by the capacitive sensor elements of the input device may be widely varied, and may include, for example, rotational motion, linear motion, taps, holds, and other gestures and any combinations thereof provided by one (single touch input) or more than one (multi-touch input) of a user's fingers across the touch sensitive surface. The capacitive sensor elements can be configured to detect input based on self capacitance (as illustrated in FIGS. 3-6) or mutual capacitance. In self capacitance, the “self” capacitance of a single electrode is measured as for example relative to ground. In mutual capacitance, the mutual capacitance between at least first and second electrodes is measured. In either case, each of the sensor elements can work independent of the other sensor elements to produce simultaneously occurring signals representative of different points of input on the touch sensitive surface at a particular time. The input device can include a controller configured to detect input sensed by the sensor elements by measuring a change in capacitance of the sensor elements.

An example of an input device configured to detect multiple simultaneous touches or near touches may be found in U.S. patent application Ser. No. 10/840,862 entitled “Multipoint Touchscreen,” filed May 6, 2004, which is incorporated herein by reference in its entirety. An example of a touch event model that can be associated with such an input device may be found in U.S. patent application Ser. No. 12/042,318 entitled “Touch Event Model,” filed Mar. 4, 2008, which is incorporated herein by reference in its entirety. An example of gestures that may be implemented on such an input device may be found in U.S. patent application Ser. No. 11/818,342 entitled “Gestures for Controlling, Manipulating, and Editing of Media Files Using Touch Sensitive Devices,” filed Jun. 13, 2007, which is incorporated herein by reference in its entirety.

The present disclosure is not limited to the input devices illustrated herein. Rather, an input device of any suitable technology or configuration for enabling detection of input in accordance with the teachings of the present disclosure can be utilized.

An input device, such as those corresponding to the embodiments described above, can be used to provide an omnidirectional electronic device. The omnidirectional electronic device can perform operations associated with a combination of inputs that can, in some cases, be recognized irrespective of the position or orientation in which they are applied to an input device of the electronic device. The inputs can include, for example, single or multi-touch taps, presses, swipes, rotations, characters and symbols. The inputs can be provided one or more times in succession and can be held for an amount of time.

This type of input recognition can be advantageous in situations in which a user desires to provide input without coordinating the input with device orientation or visual feedback from a display of the electronic device. One such situation can include the electronic device, such as a media player, being attached to clothing of a user during a workout, for example. Due to the omnidirectional nature of the media player, a user can operate the media player in the same manner without regard to whether the media player is attached to the user in an upward, downward, sideways or other orientation. As illustrated by electronic device 200, for example, an omnidirectional electronic device can be provided without a display, and include an input device that covers most of a front surface of the electronic device.

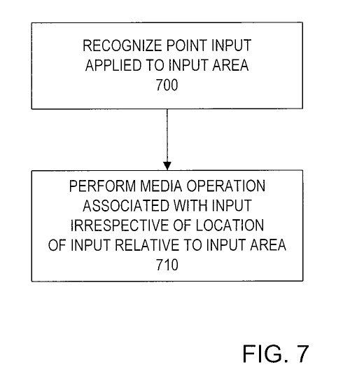

As illustrated in the process of FIG. 7, and in the context of the input devices described above, an omnidirectional electronic device can be enabled to recognize (step 700) an input applied to one or more locations of an input area of the electronic device. The omnidirectional electronic device can perform (step 710) an operation associated with the detected input irrespective of the location or locations of the input relative to the input area.

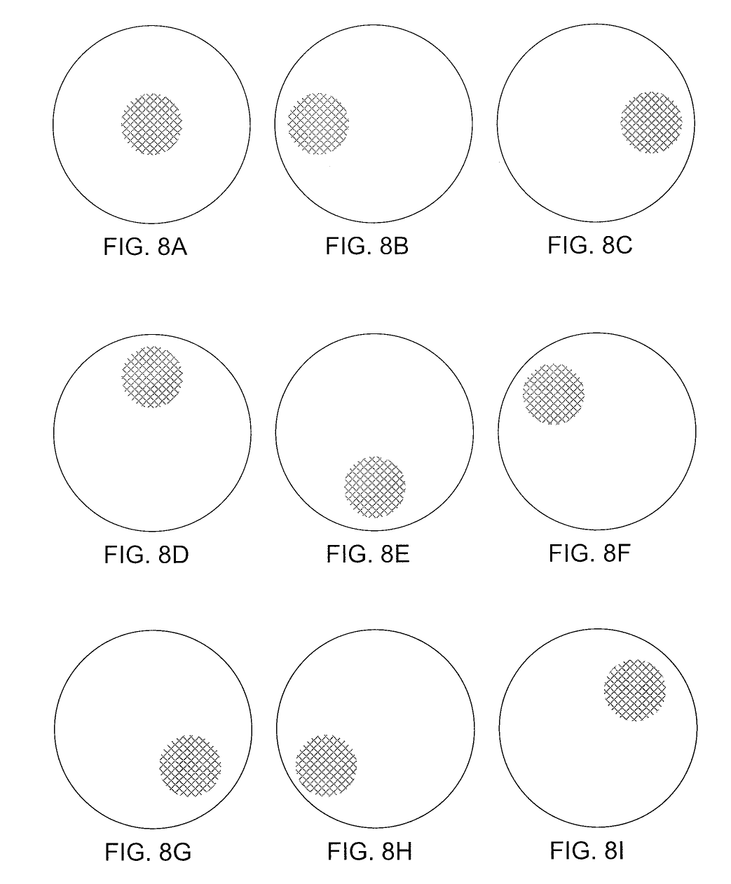

For example, FIGS. 8A-8I illustrate examples of various locations of an electronic device input area in which a single point input can be recognized by the electronic device. The single point input may comprise, for example, a tap or a press of a user's finger on the input area of the input device. The single point input may comprise a tap if the force applied to the input area by the finger falls below a threshold amount, and may comprise a press if the force meets or exceeds a threshold amount. In one embodiment, a press can cause a mechanical button sensor associated with the input device to be actuated, whereas a tap does not cause the mechanical button sensor to be actuated.

As illustrated in FIGS. 8A-8I, an omnidirectional electronic device can associate a single operation of the electronic device to the point input, irrespective of in which of the illustrated locations the input is applied, rather than associate different operations to the point input depending on the location in which the input is applied. In this manner, the omnidirectional electronic device enables gross gesture detection since a user need not apply an input at an exact location in the input area of the electronic device. This serves to enhance sightless navigation of the electronic device in some embodiments.

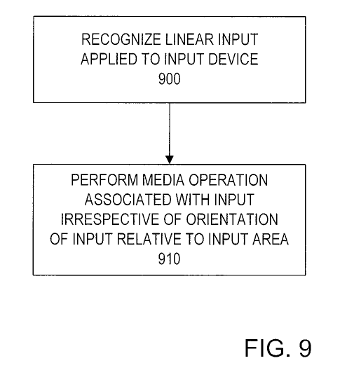

Similarly, as illustrated in the process of FIG. 9, and in the context of the input devices described above, an omnidirectional electronic device can be enabled to recognize (step 900) a linear input applied to an input area of the electronic device. A linear input comprises an input applied in a pattern involving at least one linear segment. The omnidirectional electronic device can perform (step 910) an operation associated with the detected input irrespective of the orientation of the input relative to the input area.

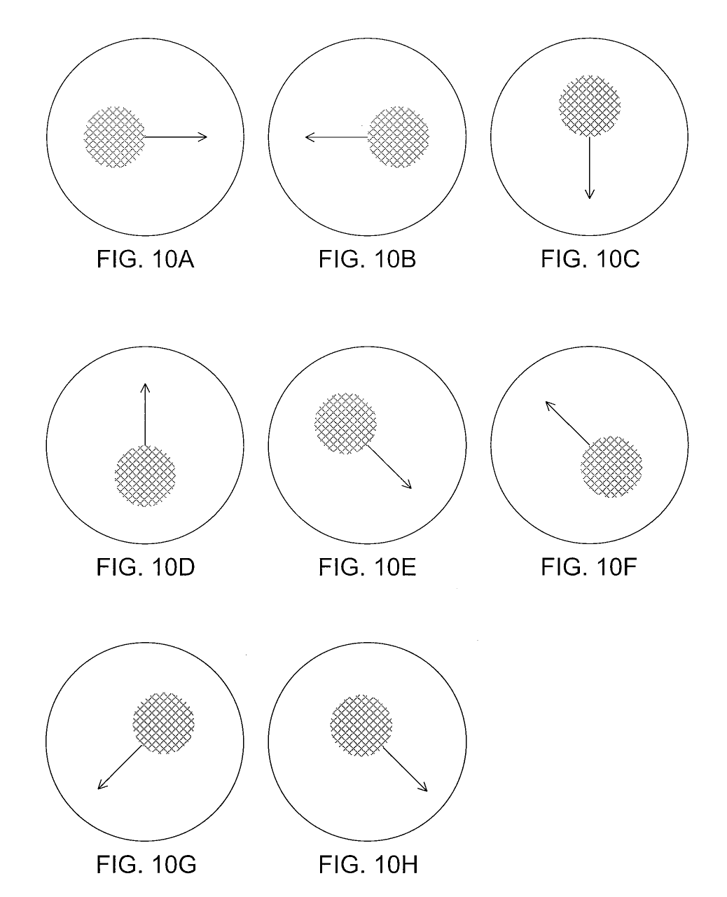

For example, FIGS. 10A-10H illustrate examples of various orientations in which a linear input can be recognized relative to an input area by an electronic device. The illustrated linear input comprises a swipe, whereby a user touches the input area of the electronic device in a unidirectional linear motion.

As illustrated in FIGS. 10A-10H, an omnidirectional electronic device can associate a single operation of the electronic device to the linear input, irrespective of in which of the illustrated orientations the input is applied, rather than associate different operations to the linear input depending on the orientation in which the input is applied. In this manner, the omnidirectional electronic device can enable sightless navigation in some embodiments since a user need not visually align the electronic device according to a particular orientation in order to apply a linear input to the input device.

An omnidirectional electronic device can perform operations associated with a combination of inputs that can, in some cases, be recognized irrespective of the position or orientation in which they are applied to an input area of the electronic device.

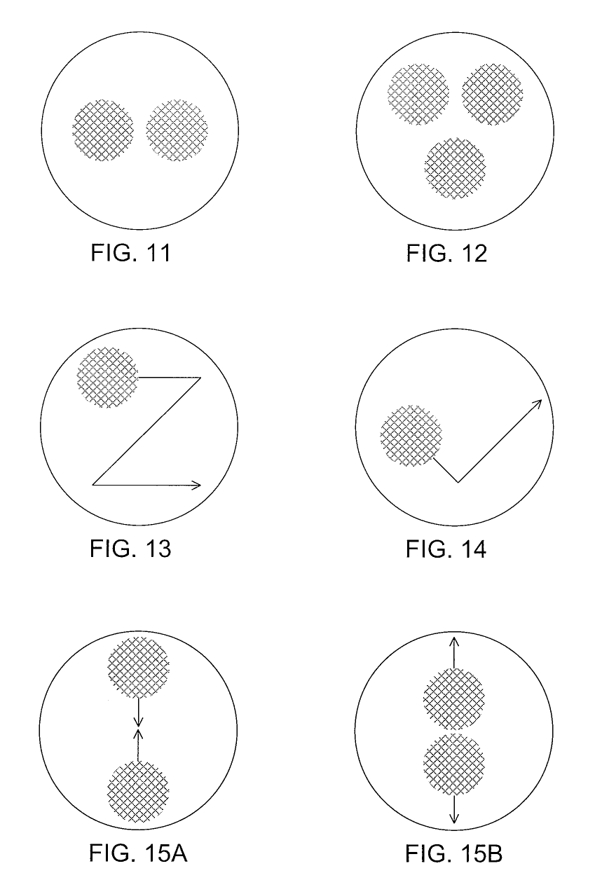

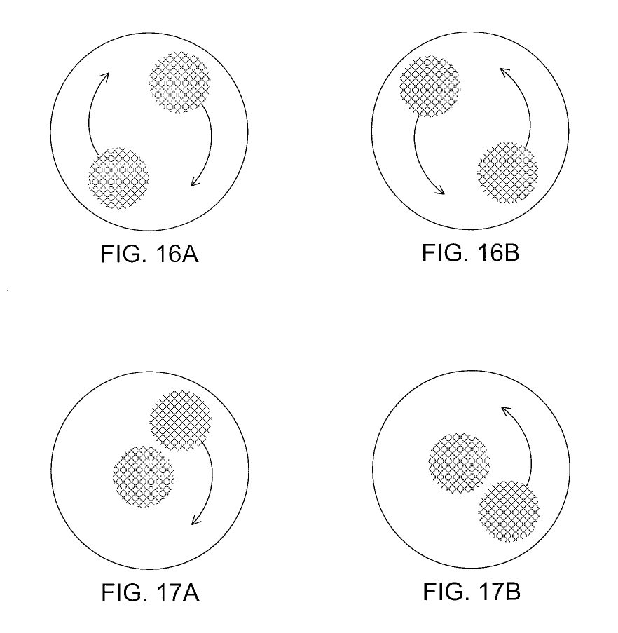

For example, FIG. 11 illustrates an example of a two-finger point input, and FIG. 12 illustrates an example of a three-finger point input. FIG. 13 illustrates an example of a linear input associated with an alphanumeric character comprising a “Z”, and FIG. 14 illustrates an example of a linear input associated with a symbol comprising a check mark. FIGS. 15A-15B illustrate examples of multi-touch linear inputs such as a pinch gesture and an expand gesture. FIGS. 16 and 17 illustrate examples of multi-touch rotational inputs, including clockwise (FIG. 16A) and counterclockwise (FIG. 16B) dual turn gestures, and clockwise (FIG. 17A) and counterclockwise (FIG. 17B) pivot and turn gestures. Each of these gestures can be recognized irrespective of the position or orientation in which they are applied to an input area of the electronic device, and can be mapped to distinct operations in the electronic device.

For example, operations of an electronic device comprising a media player can include media playback operations, such as play/pause, volume increase, volume decrease, next track, previous track, scan forward, scan rewind for example, and other operations that can be performed by the media player such as adding and deleting songs to/from a playlist, shuffling songs in a playlist, etc. TABLES 1 and 2 below illustrate examples of gestures that can be mapped to media playback operations in an omnidirectional media player in accordance with some embodiments.

TABLE 1

| OPERATION | GESTURE |
|---|---|
| Play/Pause | Press |
| Volume Increase | Rotate Clockwise |
| Volume Decrease | Rotate Counterclockwise |
| Next Track | Double-Press |
| Previous Track | Two-Finger Press |
| Scan Forward | Double-Press and Hold |
| Scan Rewind | Two-Finger Press and Hold |

TABLE 2

| OPERATION | GESTURE |
|---|---|
| Play/Pause | Press |
| Volume Increase | Rotate Clockwise |
| Volume Decrease | Rotate Counterclockwise |
| Next Track | Swipe |
| Previous Track | Two-Finger Swipe |
| Scan Forward | Swipe and Hold |
| Scan Rewind | Two-Finger Swipe and Hold |

Gestures recognizable by an electronic device in accordance with the teachings of the present disclosure can be mapped to operations of the electronic device in different ways. In one embodiment, each gesture can be mapped to only one operation of the electronic device. For example, a particular gesture, such as a multi-touch rotational input illustrated in FIG. 16A or 16B, can be mapped to only a volume control operation of the electronic device. In this example, a clockwise rotation of two fingers can trigger a volume adjustment in one direction (e.g., to increase volume), and a counterclockwise rotation of two fingers can trigger a volume adjustment in the other direction (e.g., to decrease volume). Because the gesture is not mapped to any other device operation, the operation mapped to the gesture can be provided at any time by the electronic device, irrespective of what user interface mode (e.g., location in a navigation tree in a media player) is in effect when the gesture is recognized. In another embodiment, each gesture can be mapped to different operations of the electronic device. For example, the electronic device can determine which of the different operations to perform based on a factor such as which user interface mode (e.g., location in a navigation tree in a media player) is in effect when a particular gesture is recognized. In a further embodiment, some gestures can be mapped to only one operation of the electronic device, and other gestures can be mapped to different operations of the electronic device.

In one embodiment, an electronic device can be enabled to recognize gestures only irrespective of the position or orientation in which they are applied to an input area of the electronic device. In another embodiment, an electronic device can switch detection modes between an omnidirectional mode and a directional mode. For example, in the omnidirectional mode, the electronic device can be enabled to recognize gestures irrespective of the position or orientation in which they are applied to the input area of the electronic device. In the directional mode, the electronic device can be enabled to recognize gestures with respect to the position or orientation in which they are applied to the input area of the electronic device.

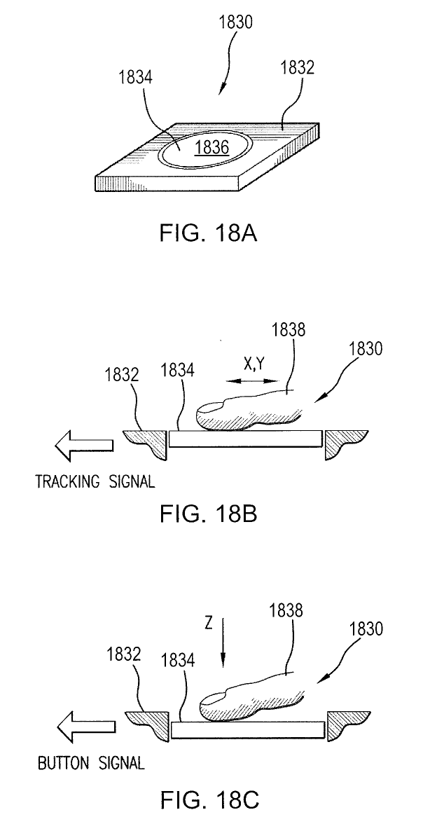

FIGS. 18A-18C illustrate operations of an input device according to some embodiments of the present disclosure. By way of example, the input device may generally correspond to any of the input devices mentioned above. In the example shown in FIG. 18A, input device 1830 can be configured to send information or data to an electronic device in order to perform an action on a display screen (e.g., via a graphical user interface). Examples of actions that may be performed include, moving an input pointer, making a selection, providing instructions, etc. The input device can interact with the electronic device through a wired connection (e.g., cable/connector) or a wireless connection (e.g., IR, Bluetooth, etc.). Input device 1830 may be a stand alone unit or it may be integrated into the electronic device. As a stand alone unit, the input device can have its own enclosure. When integrated into an electronic device, the input device can typically use the enclosure of the electronic device. In either case, the input device can be structurally coupled to the enclosure, as for example, through screws, snaps, retainers, adhesives and the like. In some cases, the input device may be removably coupled to the electronic device, as for example, through a docking station. The electronic device to which the input device may be coupled can correspond to any consumer related electronic product. By way of example, the electronic device can correspond to a computer such as a desktop computer, laptop computer or PDA, a media player such as a music player, a communication device such as a cellular phone, another input device such as a keyboard, and the like.

As shown in FIG. 18A, in this embodiment input device 1830 may include frame 1832 (or support structure) and touch pad 1834. Frame 1832 can provide a structure for supporting the components of the input device. Frame 1832 in the form of a housing can also enclose or contain the components of the input device. The components, which may include touch pad 1834, can correspond to electrical, optical and/or mechanical components for operating input device 1830. Frame 1832 may be a separate component or it may be an integral component of the housing of the electronic device.

Touch pad 1834 can provide location information for an object, such as a finger for example, in contact with or in proximity to the touch pad. This information can be used in combination with information provided by a movement indicator to generate a single command associated with the movement of the touch pad. The touch pad may be used as an input device by itself; for example, the touch pad may be used to scroll through a list of items on the device.

The shape, size and configuration of touch pad 1834 may be widely varied. In addition to the touchpad configurations disclosed above, a conventional touch pad based on the Cartesian coordinate system, or based on a Polar coordinate system can be configured to provide scrolling using rotational movements and can be configured to accept the multi-touch and gestures, for example those described herein. An example of a touch pad based on polar coordinates may be found in U.S. Pat. No. 7,046,230 which is incorporated by reference above. Furthermore, touch pad 1834 can be used in at least two different modes, which may be referred to as a relative mode and an absolute mode. In absolute mode, touch pad 1834 can, for example, report the absolute coordinates of the location at which it may be touched. For example, these would be “x” and “y” coordinates in the case of a standard Cartesian coordinate system or (r,θ) in the case of a Polar coordinate system. In relative mode, touch pad 1834 can report the direction and/or distance of change, for example, left/right, up/down, and the like. In most cases, the signals produced by touch pad 1834 can direct movement on the display screen in a direction similar to the direction of the finger as it may be moved across the surface of touch pad 1834.

Further examples of touch pad configurations may be found in U.S. patent application Ser. No. 10/949,060 entitled “Raw Data Track Pad Device and System,” filed Sep. 24, 2004, U.S. patent application Ser. No. 11/203,692 entitled “Method of Increasing the Spatial Resolution of Touch Sensitive Devices,” filed Aug. 15, 2005, and U.S. patent application Ser. No. 11/818,395 entitled “Touch Screen Stack-Ups,” filed Jun. 13, 2007, all of which are incorporated herein by reference in their entireties.

Further examples of touch pad sensing may be found in U.S. patent application Ser. No. 10/903,964 entitled “Gestures for Touch Sensitive Input Devices,” filed Jul. 30, 2004, U.S. patent application Ser. No. 11/038,590 entitled “Mode-Based Graphical User Interfaces for Touch Sensitive Input Devices,” filed Jan. 18, 2005, U.S. patent application Ser. No. 11/048,264 entitled “Gestures for Touch Sensitive Input Devices,” filed Jan. 31, 2005, U.S. patent application Ser. No. 11/232,299 entitled “System and Method for Processing Raw Data of Track Pad Device,” filed Sep. 21, 2005, and U.S. patent application Ser. No. 11/619,464 entitled “Multi-Touch Input Discrimination,” filed Jan. 3, 2007, all of which are incorporated herein by reference in their entireties.

The shape of touch pad 1834 may be widely varied. For example, it may be circular, oval, square, rectangular, triangular, and the like. In general, the outer perimeter can define the working boundary of touch pad 1834. In the embodiment illustrated in FIG. 18, the touch pad may be circular. Circular touch pads can allow a user to continuously swirl a finger in a free manner, i.e., the finger may be rotated through 360 degrees of rotation without stopping. This form of motion can produce incremental or accelerated scrolling through a list of songs being displayed on a display screen, for example. Furthermore, the user may rotate his or her finger tangentially from all sides, thus providing more finger position range. Both of these features may help when performing a scrolling function. Furthermore, the size of touch pad 1834 can accommodate manipulation by a user (e.g., the size of a finger tip or larger).

Touch pad 1834, which can generally take the form of a rigid platform. The rigid platform may be planar, convex or concave, and may include touchable outer surface 1836, which may be textured, for receiving a finger or other object for manipulation of the touch pad. Although not shown in FIG. 18A, beneath touchable outer surface 1836 can be a sensor arrangement that may be sensitive to such things as the pressure and movement of a finger thereon. The sensor arrangement may typically include a plurality of sensors that can be configured to activate as the finger sits on, taps on or passes over them. In the simplest case, an electrical signal can be produced each time the finger is positioned over a sensor. The number of signals in a given time frame may indicate location, direction, speed and acceleration of the finger on touch pad 1834, i.e., the more signals, the more the user moved his or her finger. In most cases, the signals can be monitored by an electronic interface that converts the number, combination and frequency of the signals into location, direction, speed and acceleration information. This information can then be used by the electronic device to perform the desired control function on the display screen. The sensor arrangement may be widely varied. By way of example, the sensors can be based on resistive sensing, surface acoustic wave sensing, pressure sensing (e.g., strain gauge), optical sensing, capacitive sensing and the like.

In the embodiment illustrated in FIG. 18, touch pad 1834 may be based on capacitive sensing. In most cases, the capacitive touch pad may include a protective shield, one or more electrode layers, a circuit board and associated electronics including an application specific integrated circuit (ASIC). The protective shield can be placed over the electrodes, the electrodes can be mounted on the top surface of the circuit board, and the ASIC can be mounted on the bottom surface of the circuit board. The protective shield may serve to protect the underlayers and to provide a surface for allowing a finger to slide thereon. The surface may generally be smooth so that the finger does not stick to it when moved. The protective shield also may provide an insulating layer between the finger and the electrode layers. The electrode layer may include a plurality of spatially distinct electrodes. Any suitable number of electrodes can be used. As the number of electrodes increases, the resolution of the touch pad also increases.

In accordance with one embodiment, touch pad 1834 can be movable relative to the frame 1832. This movement can be detected by a movement detector that generates another control signal. By way of example, touch pad 1834 in the form of the rigid planar platform can rotate, pivot, slide, translate, flex and/or the like relative to frame 1832. Touch pad 1834 can be coupled to frame 1832 and/or it can be movably restrained by frame 1832. By way of example, touch pad 1834 can be coupled to frame 1832 through axels, pin joints, slider joints, ball and socket joints, flexure joints, magnets, cushions and/or the like. Touch pad 1834 can also float within a space of the frame (e.g., gimbal). It should be noted that input device 1830 may additionally include a combination of joints such as a pivot/translating joint, pivot/flexure joint, pivot/ball and socket joint, translating/flexure joint, and the like to increase the range of movement (e.g., increase the degree of freedom).

When moved, touch pad 1834 can be configured to actuate a movement detector circuit that generates one or more signals. The circuit may generally include one or more movement detectors such as switches, sensors, encoders, and the like.

In the embodiment illustrated in FIG. 18, touch pad 1834 can be part of a depressible platform. The touch pad can operate as a button and perform one or more mechanical clicking actions. Multiple functions or the same function of the device may be accessed by depressing the touch pad 1834 in different locations. A movement detector signals that touch pad 1834 has been depressed, and touch pad 1834 signals a location on the platform that has been touched. By combining both the movement detector signals and touch pad signals, touch pad 1834 acts like multiple buttons such that depressing the touch pad at different locations corresponds to different buttons. As shown in FIGS. 18B and 18C, according to one embodiment touch pad 1834 can be capable of moving between an upright position (FIG. 18B) and a depressed position (FIG. 18C) when a requisite amount of force from finger 1838, palm, hand or other object is applied to touch pad 1834. Touch pad 1834 can be spring biased in the upright position, as for example through a spring member. Touch pad 1834 moves to the depressed position when the spring bias is overcome by an object pressing on touch pad 1834.

As shown in FIG. 18B, touch pad 1834 generates tracking signals when an object such as a user's finger is moved over the top surface of the touch pad in the x, y plane. As shown in FIG. 18C, in the depressed position (z direction), touch pad 1834 generates positional information and a movement indicator generates a signal indicating that touch pad 1834 has moved. The positional information and the movement indication can be combined to form a button command. Different button commands or the same button command can correspond to depressing touch pad 1834 in different locations. The button commands may be used for various functionalities including, but not limited to, making selections or issuing commands associated with operating an electronic device. By way of example, in the case of a music player, the button commands may be associated with opening a menu, playing a song, fast forwarding a song, seeking through a menu and the like.

To elaborate, touch pad 1834 can be configured to actuate a movement detector, which together with the touch pad positional information, can form a button command when touch pad 1834 is moved to the depressed position. The movement detector can be located within frame 1832 and coupled to touch pad 1834 and/or frame 1832. The movement detector may be any combination of switches and sensors. Switches can be generally configured to provide pulsed or binary data such as activate (on) or deactivate (off). By way of example, an underside portion of touch pad 1834 can be configured to contact or engage (and thus activate) a switch when the user presses on touch pad 1834. The sensors, on the other hand, can be generally configured to provide continuous or analog data. By way of example, the sensor can be configured to measure the position or the amount of tilt of touch pad 1834 relative to the frame when a user presses on the touch pad 1834. Any suitable mechanical, electrical and/or optical switch or sensor may be used. For example, tact switches, force sensitive resistors, pressure sensors, proximity sensors, and the like may be used. In some case, the spring bias for placing touch pad 1834 in the upright position may be provided by a movement detector that includes a spring action. In other embodiments, input device 1830 can include one or more movement detectors in various locations positioned under and/or above touch pad 1834 to form button commands associated with the particular locations in which the movement detector is actuated.

Touch pad 1834 may can also be configured to provide a force feedback response. An example of touch pad configuration providing a haptic feedback response may be found in U.S. Pat. No. 6,337,678 entitled “Force Feedback Computer Input and Output Device with Coordinated Haptic Elements,” which is incorporated herein by reference in its entirety.

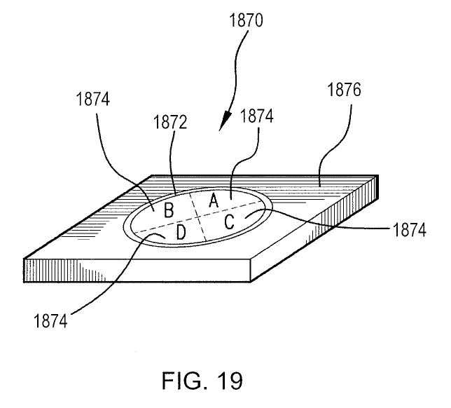

FIG. 19 illustrates a simplified perspective diagram of input device 1870. Like the input device shown in the embodiment of FIGS. 18A-18C, this input device 1870 incorporates the functionality of one or more buttons directly into touch pad 1872, i.e., the touch pad acts like a button. In this embodiment, however, touch pad 1872 can be divided into a plurality of independent and spatially distinct button zones 1874. Button zones 1874 may represent regions of the touch pad 1872 that can be moved by a user to implement distinct button functions or the same button function. The dotted lines may represent areas of touch pad 1872 that make up an individual button zone. Any number of button zones may be used, for example, two or more, four, eight, etc. In the embodiment illustrated in FIG. 19, touch pad 1872 may include four button zones 1874 (i.e., zones A-D).

As should be appreciated, the button functions generated by pressing on each button zone may include selecting an item on the screen, opening a file or document, executing instructions, starting a program, viewing a menu, and/or the like. The button functions may also include functions that make it easier to navigate through the electronic system, as for example, zoom, scroll, open different menus, home the input pointer, perform keyboard related actions such as enter, delete, insert, page up/down, and the like. In the case of a music player, one of the button zones may be used to access a menu on the display screen, a second button zone may be used to seek forward through a list of songs or fast forward through a currently playing song, a third button zone may be used to seek backwards through a list of songs or fast rearward through a currently playing song, and a fourth button zone may be used to pause or stop a song that may be in the process of being played.

To elaborate, touch pad 1872 can be capable of moving relative to frame 1876 so as to create a clicking action. Frame 1876 can be formed from a single component or a combination of assembled components. The clicking action can actuate a movement detector contained inside frame 1876. The movement detector can be configured to sense movements of the button zones during the clicking action and to send a signal corresponding to the movement to the electronic device. By way of example, the movement detectors may be switches, sensors and/or the like.

In addition, touch pad 1872 can be configured to send positional information on what button zone may be acted on when the clicking action occurs. The positional information can allow the device to determine which button zone to activate when the touch pad is moved relative to the frame.

The movements of each of button zones 1874 may be provided by various rotations, pivots, translations, flexes and the like. In one embodiment, touch pad 1872 can be configured to gimbal relative to frame 1876. By gimbal, it is generally meant that the touch pad 1872 can float in space relative to frame 1876 while still being constrained thereto. The gimbal can allow the touch pad 1872 to move in single or multiple degrees of freedom (DOF) relative to the housing, for example, movements in the x, y and/or z directions and/or rotations about the x, y, and/or z axes (θxθyθz).

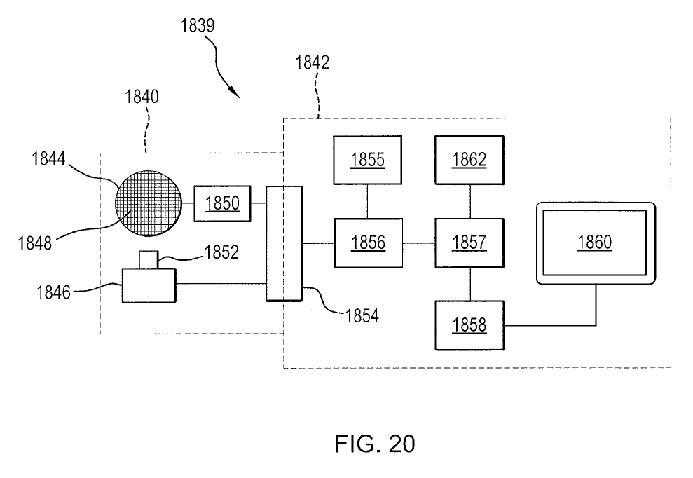

FIG. 20 illustrates an example of a simplified block diagram of a computing system 1839. The computing system may generally include input device 1840 operatively connected to computing device 1842. By way of example, input device 1840 can generally correspond to input device 1830 shown in FIGS. 18A-18C, and the computing device 1842 can correspond to a computer, PDA, media player or the like. As shown, input device 1840 may include depressible touch pad 1844 and one or more movement detectors 1846. Touch pad 1844 can be configured to generate tracking signals and movement detector 1846 can be configured to generate a movement signal when the touch pad is depressed. Although touch pad 1844 may be widely varied, in this embodiment, touch pad 1844 can include capacitance sensors 1848 and control system 1850 (which can generally correspond to the sensor controller described above) for acquiring position signals from sensors 1848 and supplying the signals to computing device 1842. Control system 1850 can include an application specific integrated circuit (ASIC) that can be configured to monitor the signals from sensors 1848, to compute the absolute location, angular location, direction, speed and/or acceleration of the monitored signals and to report this information to a processor of computing device 1842. Movement detector 1846 may also be widely varied. In this embodiment, however, movement detector 1846 can take the form of a switch that generates a movement signal when touch pad 1844 is depressed. Movement detector 1846 can correspond to a mechanical, electrical or optical style switch. In one particular implementation, movement detector 1846 can be a mechanical style switch that includes protruding actuator 1852 that may be pushed by touch pad 1844 to generate the movement signal. By way of example, the switch may be a tact or dome switch.

Both touch pad 1844 and movement detector 1846 can be operatively coupled to computing device 1842 through communication interface 1854. The communication interface provides a connection point for direct or indirect connection between the input device and the electronic device. Communication interface 1854 may be wired (wires, cables, connectors) or wireless (e.g., transmitter/receiver).

Referring to computing device 1842, it may include processor 1857 (e.g., CPU or microprocessor) configured to execute instructions and to carry out operations associated with computing device 1842. For example, using instructions retrieved from memory, the processor can control the reception and manipulation of input and output data between components of computing device 1842. Processor 1857 can be configured to receive input from both movement detector 1846 and touch pad 1844 and can form a signal/command that may be dependent upon both of these inputs. In most cases, processor 1857 can execute instruction under the control of an operating system or other software. Processor 1857 may be a single-chip processor or may be implemented with multiple components.

Computing device 1842 may also include input/output (I/O) controller 1856 that can be operatively coupled to processor 1857. (I/O) controller 1856 can be integrated with processor 1857 or it may be a separate component as shown. I/O controller 1856 can generally be configured to control interactions with one or more I/O devices that may be coupled to the computing device 1842, as for example input device 1840 and orientation detector 1855, such as an accelerometer. I/O controller 1856 can generally operate by exchanging data between computing device 1842 and I/O devices that desire to communicate with computing device 1842.

Computing device 1842 may also include display controller 1858 that can be operatively coupled to processor 1857. Display controller 1858 can be integrated with processor 1857 or it may be a separate component as shown. Display controller 1858 can be configured to process display commands to produce text and graphics on display screen 1860. By way of example, display screen 1860 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays arid the like. In the embodiment illustrated in FIG. 20, the display device corresponds to a liquid crystal display (LCD).

In some cases, processor 1857 together with an operating system operates to execute computer code and produce and use data. The computer code and data can reside within program storage area 1862 that may be operatively coupled to processor 1857. Program storage area 1862 can generally provide a place to hold data that may be used by computing device 1842. By way of example, the program storage area may include Read-Only Memory (ROM), Random-Access Memory (RAM), hard disk drive and/or the like. The computer code and data could also reside on a removable program medium and loaded or installed onto the computing device when needed. In one embodiment, program storage area 1862 can be configured to store information for controlling how the tracking and movement signals generated by the input device may be used, either alone or in combination for example, by computing device 1842 to generate an input event command, such as a single button press for example.

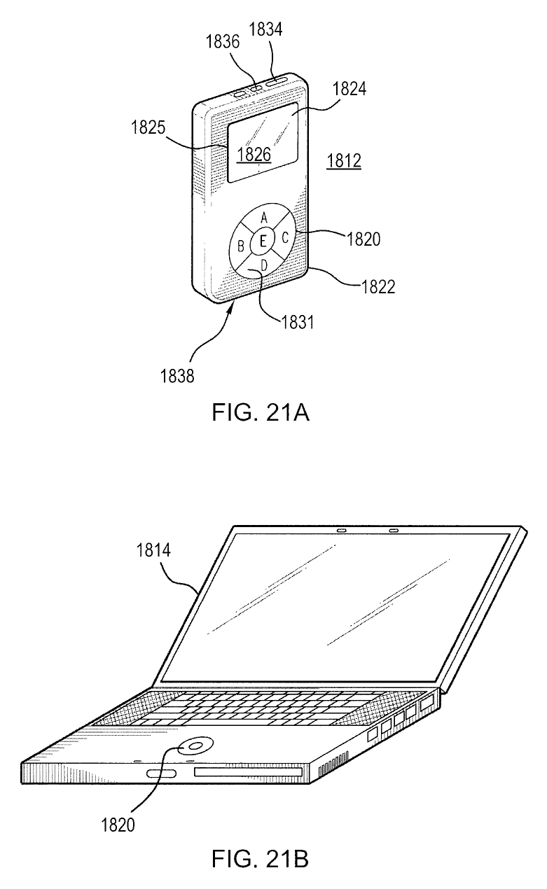

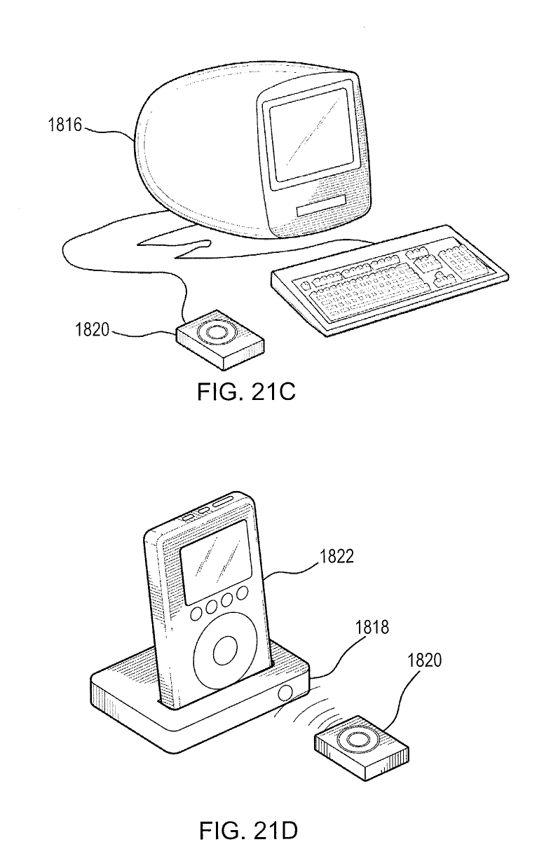

FIGS. 21A-21D illustrate applications of an input device according to some embodiments of the present disclosure. As previously mentioned, the input devices described herein can be integrated into an electronic device or they can be separate stand alone devices. FIGS. 21A-21D show some implementations of input device 1820 integrated into an electronic device. FIG. 21A shows input device 1820 incorporated into media player 1812. FIG. 21B shows input device 1820 incorporated into laptop computer 1814. FIGS. 21C and 21D, on the other hand, show some implementations of input device 1820 as a stand alone unit. FIG. 21C shows input device 1820 as a peripheral device that can be connected to desktop computer 1816. FIG. 21D shows input device 1820 as a remote control that wirelessly connects to docking station 1818 with media player 1822 docked therein. It should be noted, however, that in some embodiments the remote control can also be configured to interact with the media player (or other electronic device) directly, thereby eliminating the need for a docking station. An example of a docking station for a media player may be found in U.S. patent application Ser. No. 10/423,490, entitled “Media Player System,” filed Apr. 25, 2003, which is incorporated herein by reference in its entirety. It should be noted that these particular embodiments do not limit the present disclosure and that many other devices and configurations may be used.

Referring back to FIG. 21A, media player 1812, housing 1822 and display screen 1824 may generally correspond to those described above. As illustrated in the embodiment of FIG. 21A, display screen 1824 can be visible to a user of media player 1812 through opening 1825 in housing 1822 and through transparent wall 1826 disposed in front of opening 1825. Although transparent, transparent wall 1826 can be considered part of housing 1822 since it helps to define the shape or form of media player 1812.

Media player 1812 may also include touch pad 1820 such as any of those previously described. Touch pad 1820 can generally consist of touchable outer surface 1831 for receiving a finger for manipulation on touch pad 1820. Although not illustrated in the embodiment of FIG. 21A, beneath touchable outer surface 1831 a sensor arrangement can be configured in a manner as previously described. Information provided by the sensor arrangement can be used by media player 1812 to perform the desired control function on display screen 1824. For example, a user may easily scroll through a list of songs by swirling the finger around touch pad 1820.

In addition to above, the touch pad may also include one or more movable buttons zones A-D as well as a center button E for example. The button zones can be configured to provide one or more dedicated control functions for making selections or issuing commands associated with operating media player 1812. By way of example, in the case of an MP3 music player, the button functions can be associated with opening a menu, playing a song, fast forwarding a song, seeking through a menu, making selections and the like. In some embodiments, the button functions can be implemented via a mechanical clicking action.

The position of touch pad 1820 relative to housing 1822 may be widely varied. For example, touch pad 1820 can be placed at any external surface (e.g., top, side, front, or back) of housing 1822 accessible to a user during manipulation of media player 1812. In some embodiments, touch sensitive surface 1831 of touch pad 1820 can be completely exposed to the user. In the embodiment illustrated in FIG. 21A, touch pad 1820 can be located in a lower front area of housing 1822. Furthermore, touch pad 1820 can be recessed below, level with, or extend above the surface of housing 1822. In the embodiment illustrated in FIG. 21A, touch sensitive surface 1831 of touch pad 1820 can be substantially flush with the external surface of housing 1822.

The shape of touch pad 1820 may also be widely varied. Although illustrated as circular in the embodiment of FIG. 21A, the touch pad can also be square, rectangular, triangular, and the like for example. More particularly, the touch pad can be annular, i.e., shaped like or forming a ring. As such, the inner and outer perimeter of the touch pad can define the working boundary of the touch pad.

Media player 1812 may also include hold switch 1834. Hold switch 1834 can be configured to activate or deactivate the touch pad and/or buttons associated therewith for example. This can be generally done to prevent unwanted commands by the touch pad and/or buttons, as for example, when the media player is stored inside a user's pocket. When deactivated, signals from the buttons and/or touch pad cannot be sent or can be disregarded by the media player. When activated, signals from the buttons and/or touch pad can be sent and therefore received and processed by the media player.

Moreover, media player 1812 may also include one or more headphone jacks 1836 and one or more data ports 1838. Headphone jack 1836 can be capable of receiving a headphone connector associated with headphones configured for listening to sound being outputted by media player 1812. Data port 1838, on the other hand, can be capable of receiving a data connector/cable assembly configured for transmitting and receiving data to and from a host device such as a general purpose computer (e.g., desktop computer, portable computer). By way of example, data port 1838 can be used to upload or download audio, video and other images to and from media player 1812. For example, the data port can be used to download songs and play lists, audio books, ebooks, photos, and the like into the storage mechanism of the media player.

Data port 1838 may be widely varied. For example, the data port can be a PS/2 port, a serial port, a parallel port, a USB port, a Firewire port and/or the like. In some embodiments, data port 1838 can be a radio frequency (RF) link or optical infrared (IR) link to eliminate the need for a cable. Although not illustrated in the embodiment of FIG. 21A, media player 1812 can also include a power port that receives a power connector/cable assembly configured for delivering power to media player 1812. In some cases, data port 1838 can serve as both a data and power port. In the embodiment illustrated in FIG. 21A, data port 1838 can be a USB port having both data and power capabilities.

Although only one data port may be shown, it should be noted that this does not limit the present disclosure and that multiple data ports may be incorporated into the media player. In a similar vein, the data port can include multiple data functionality, i.e., integrating the functionality of multiple data ports into a single data port. Furthermore, it should be noted that the position of the hold switch, headphone jack and data port on the housing may be widely varied, in that they are not limited to the positions shown in FIG. 21A. They can be positioned almost anywhere on the housing (e.g., front, back, sides, top, bottom). For example, the data port can be positioned on the top surface of the housing rather than the bottom surface as shown.

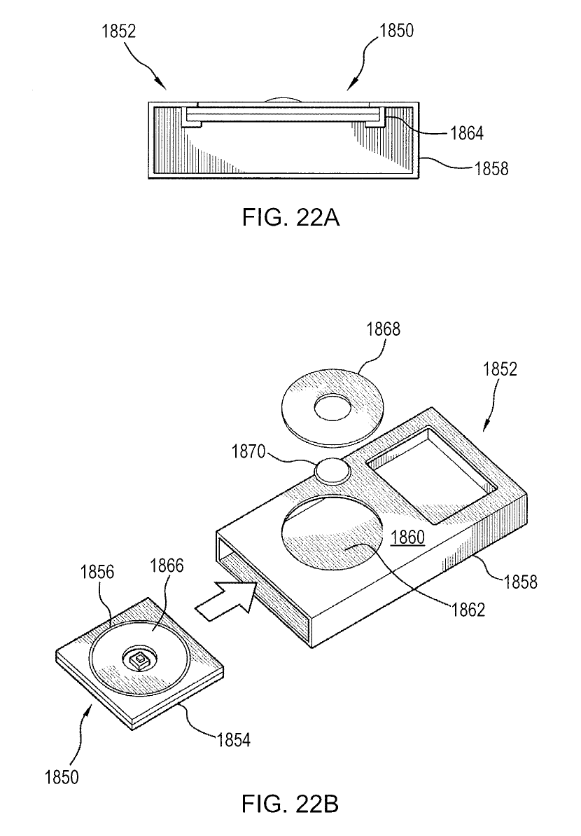

FIGS. 22A and 22B illustrate installation of an input device into a media player according to some embodiments of the present disclosure. By way of example, input device 1850 may correspond to any of those previously described and media player 1852 may correspond to the one shown in FIG. 21A. As shown, input device 1850 may include housing 1854 and touch pad assembly 1856. Media player 1852 may include shell or enclosure 1858. Front wall 1860 of shell 1858 may include opening 1862 for allowing access to touch pad assembly 1856 when input device 1850 is introduced into media player 1852. The inner side of front wall 1860 may include channel or track 1864 for receiving input device 1850 inside shell 1858 of media player 1852. Channel 1864 can be configured to receive the edges of housing 1854 of input device 1850 so that input device 1850 can be slid into its desired place within shell 1858. The shape of the channel can have a shape that generally coincides with the shape of housing 1854. During assembly, circuit board 1866 of touch pad assembly 1856 can be aligned with opening 1862 and cosmetic disc 1868 and button cap 1870 can be mounted onto the top side of circuit board 1866 for example. As shown in the embodiment illustrated in FIG. 22B, cosmetic disc 1868 can have a shape that may generally coincide with opening 1862. The input device can be held within the channel via a retaining mechanism such as screws, snaps, adhesives, press fit mechanisms, crush ribs and the like for example.

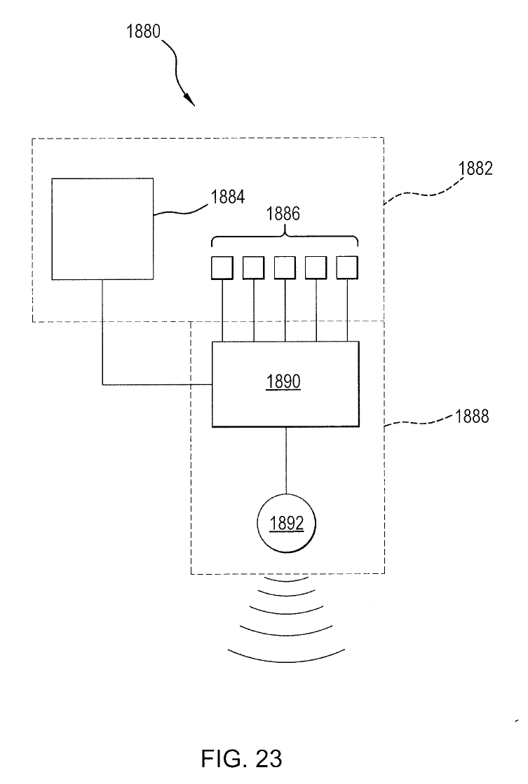

FIG. 23 illustrates a simplified block diagram of a remote control incorporating an input device according to some embodiments of the present disclosure. By way of example, input device 1882 may generally correspond to any of the previously described input devices. In this particular embodiment, input device 1882 may correspond to the input device shown in FIGS. 18A-18C, thus the input device may include touch pad 1884 and plurality of switches 1886. Touch pad 1884 and switches 1886 can be operatively coupled to wireless transmitter 1888. Wireless transmitter 1888 can be configured to transmit information over a wireless communication link so that an electronic device that has receiving capabilities can receive the information over the wireless communication link. Wireless transmitter 1888 may be widely varied. For example, it can be based on wireless technologies such as FM, RF, Bluetooth, 802.11 UWB (ultra wide band), IR, magnetic link (induction) and the like for example. In the embodiment illustrated in FIG. 23, wireless transmitter 1888 can be based on IR. IR generally refers to wireless technologies that convey data through infrared radiation. As such, wireless transmitter 1888 may generally include IR controller 1890. IR controller 1890 can take the information reported from touch pad 1884 and switches 1886 and convert this information into infrared radiation, as for example using light emitting diode 1892.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate processors or controllers may be performed by the same processors or controllers. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in a plurality of units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

What is claimed is:

1. A device comprising:
an input area, and
a processor configured to recognize a first input applied to the input area in a first pattern, the first pattern and the input area defining a relative orientation, the processor being configured to perform a first function associated with the first pattern irrespective of the relative orientation defined by the first pattern and the input area.

2. The device of claim 1, wherein the processor is configured to recognize a first input comprising a single touch input.

3. The device of claim 1, wherein the processor is configured to recognize a first input comprising a multi-touch input.

4. The device of claim 1, wherein the processor is configured to recognize a first input comprising an input that is at least temporarily stationary relative to the input area.

5. The device of claim 1, wherein the processor is configured to recognize a first input comprising a unidirectional swipe.

6. The device of claim 1, wherein the processor is configured to recognize a first input comprising a gestural input associated with an alphanumeric character.

7. The device of claim 1, wherein the processor is configured to recognize a first input comprising a gestural input associated with a symbol.

8. The device of claim 1, wherein the processor is configured to recognize a second input applied to the input area in a second pattern and perform a second function associated with the second pattern.

9. The device of claim 8, wherein the processor is configured to recognize a second input comprising a single touch input.

10. The device of claim 8, wherein the processor is configured to recognize a second input comprising a multi-touch input.

11. The device of claim 8, wherein the processor is configured to recognize a second input comprising an input that is at least temporarily stationary relative to the input area.

12. The device of claim 1, wherein the processor is configured to
recognize a second input applied to the input area at one or more locations and perform a second function associated with the second input.

13. The device of claim 12, wherein the processor is configured to recognize a second input comprising a single touch input.

14. The device of claim 12, wherein the processor is configured to recognize a second input comprising a multi-touch input.

15. The device of claim 12, wherein the processor is configured to recognize a second input comprising an input that is at least temporarily stationary relative to the input area.

16. The device of claim 12, wherein the processor is configured to recognize a second input comprising a tap.

17. The device of claim 12, wherein the processor is configured to recognize a second input comprising a press.

18. The device of claim 1, wherein the first input is mapped to only to the first function.

19. The device of claim 18, wherein the first input comprises a multi-touch input, and the first function comprises a volume control operation.

20. The device of claim 19, wherein the multi-touch input comprises a two-finger rotational input.

21. A device comprising:
an input area, and
a processor configured to recognize a unidirectional input motion applied to the input area, the unidirectional input motion defining a direction of motion relative to the input area, the processor being configured to perform a first function associated with the unidirectional input motion irrespective of the direction of motion relative to the input area.

22. The device of claim 21, wherein the processor is configured to recognize a unidirectional motion comprising a single touch input.

23. The device of claim 21, wherein the processor is configured to recognize a unidirectional motion comprising a multi-touch input.

24. A method, comprising:
providing a device comprising an input area,
recognizing a first input applied to the input area in a first pattern, the first pattern and the input area defining a relative orientation, and
performing a first function in response to the first pattern irrespective of the relative orientation defined by the first pattern and the input area.

25. The device of claim 1 wherein the first pattern comprises a linear pattern.

26. The device of claim 8 wherein the second pattern comprises a curvilinear pattern.

27. The method of claim 24 wherein the first pattern comprises a linear pattern.

28. The method of claim 24 wherein the first pattern comprises a curvilinear pattern.
